(19) United States
(12) Patent Application Publication
(10) Pub. No.: US 2020/0217047 A1
(43) Pub. Date: Jul. 9, 2020

(54) SYSTEM AND METHOD TO DETERMINE MECHANICAL WEAR IN A MACHINE HAVING ACTUATORS

(71) Applicant: DEERE & COMPANY, Moline, IL (US)

(72) Inventor: Lance R. Sherlock, Dubuque, IA (US)

(21) Appl. No.: 16/242,681

(22) Filed: Jan. 8, 2019

(51) Int. Cl. E02F 9/26; E02F 9/22; F15B 15/28; F15B 19/00

(52) U.S. Cl. CPC E02F 9/26; F15B 19/00; F15B 15/28; E02F 9/22

(57) ABSTRACT

A system and method for identifying wear of a mechanical actuator configured to move an implement operatively connected to a work machine. The mechanical sensor includes a sensor, a cylinder, and a rod configured to extend and retract from the cylinder, wherein the mechanical actuator is operatively connected to the implement and to the work machine to move the implement with respect to the work machine in response to a machine command transmitted by an electronic control module. A retracted reference location of the rod is determined based on a minimum distance between the implement and the work machine. An extended reference location of the rod is identified based on a maximum distance between the implement and the work machine. The retracted reference location or the extended reference location is compared to one or more threshold values to generate a comparison value. Mechanical wear is determined based on the comparison value.

### FIELD OF THE DISCLOSURE

The present invention generally relates to a machine having actuators, and more particularly to a control system and method to determine an amount of wear of a work machine or of the actuators of the work machine resulting from use.

### BACKGROUND

Work vehicles are configured to perform a wide variety of tasks including use as construction vehicles, forestry vehicles, lawn maintenance vehicles, as well as on-road vehicles such as those used to plow snow, spread salt, or vehicles with towing capability. Additionally, work vehicles typically perform work with one or more implements that are moved by actuators in response to commands provided by a user of the work vehicle, or by commands that are generated automatically by a control system, either located within the vehicle or located externally to the vehicle.

In one example such as a bulldozer, the bulldozer is equipped with an implement, such as a blade, which is moved by actuators responsive to implement commands. The blade is used to push dirt and other materials to a desired location. To accomplish these tasks, the position of the blade is adjusted by one or more actuators. On a utility crawler dozer for instance, the blade is typically adjustable in different directions, which includes raising and lowering of the blade, adjusting a pitch position of the blade by moving the top portion of the blade forward and backward relative to a lower pivot point, and an angle of the blade by moving the blade left or right about a center pivot point.

Other work vehicles include, but are not limited to, excavators, loaders, and motor graders. In motor graders, for instance, a drawbar assembly is attached toward the front of the grader, which is pulled by the grader as the grader moves forward. The drawbar assembly rotatably supports a circle drive member at a free end of the drawbar assembly and the circle drive member supports a work implement such as the blade, also known as a mold board. The angle of the work implement beneath the drawbar assembly can be adjusted by the rotation of the circle drive member relative to the drawbar assembly.

In addition, to the blade being rotated about a rotational fixed axis, the blade is also adjustable to a selected angle with respect to the circle drive member. This angle is known as blade slope. The elevation of the blade is also adjustable.

These work vehicle include an actuator coupled to the implement either directly or indirectly through the actuator. In many instances, the actuator includes a hydraulic actuator, also known as a hydraulic cylinder. The hydraulic cylinder includes a housing coupled to a first part of vehicle, such as a frame, and a rod coupled to the implement, either directly or indirectly through an arm or other part of the work vehicle.

Many different parts of the work vehicle experience wear, including the hydraulic cylinder. For instance, the cylinder arm typically includes an aperture coupled to another part, located on the work vehicle, by a connector such as a pin. Continued use of the implement over a period of time can and often does cause mechanical wear to occur at the aperture due to the repetitive motion. In other cases, the wear can occur at the part to which the cylinder arm or the housing is connected. If the wear becomes too great, the motion of the implement is affected such that the directed movement is less precise than desired. What is needed therefore is a system and method to determine mechanical wear in a work machine having actuators.

### SUMMARY

In one embodiment, there is provided a method for identifying wear of a mechanical actuator having a sensor, a cylinder, and a piston rod configured to extend and retract from the cylinder, wherein the mechanical actuator is operatively connected to a first part of a machine and to a second part of the machine to move the first part with respect to the second part in response to a machine command transmitted by an electronic control module. The method includes: identifying, with the sensor, a retracted reference location of the piston rod based on a minimum distance between the first part and the second part; identifying, with the sensor, an extended reference location of the piston rod based on a maximum distance between the first part and the second part; comparing one of the retracted reference location and extended reference location to one or more threshold values to generate a comparison value; and identifying an amount of mechanical wear experienced by one of the mechanical actuator or the machine based on the comparison value.

In one example of this embodiment, the identified amount of mechanical wear is wear experienced by the piston rod of the mechanical actuator. In a second example of this embodiment, the identified amount of mechanical wear is wear experienced by one of the first part or the second part. In a third example of this embodiment, the one or more threshold values of the comparing step includes a first threshold value and a second threshold value, wherein the first threshold value is compared to the retracted reference value and the second threshold value is compared to the extended threshold value to identify an amount of mechanical wear of the mechanical actuator.

In a fourth example of this embodiment, the identifying step further comprises identifying an amount of mechanical wear experienced by the piston rod. In a fifth example of this embodiment, the first part of the machine is an implement, the second part of the machine is one of a frame or a moving part operatively connect to the frame, and the piston rod includes an aperture, wherein the aperture of the piston rod is coupled the implement and the mechanical wear occurs at the piston rod. In a sixth example of this embodiment, the piston rod includes a fully extended position and a position of the piston rod at the extended reference location does not extend to the fully extended position. In a seventh example of this embodiment, the piston rod includes a fully retracted position and a position of the piston rod at the retracted reference location does not extend to the fully retracted position.

In another embodiment, there is provided a work vehicle including a first part configured to move with respect to a second part, wherein the first part is displaced from the second part at a minimum distance, at a maximum distance, and at locations therebetween. A hydraulic actuator includes a sensor, an actuator body, and an actuator arm, wherein the actuator arm is operatively connected to the first part and the actuator body is operatively connected to the second part. A user control device is operatively connected to the hydraulic actuator and is configured to transmit a first command signal to move the actuator arm of the hydraulic actuator with respect to the actuator body. An electronic user interface is configured to provide status information of the work vehicle. An electronic control unit is operatively connected to the sensor, to the user control device, and to the electronic user interface. The electronic control unit includes a processor and a memory, wherein the memory is configured to store program instructions and the processor is configured to execute the stored program instructions to: identify, with the sensor, a starting location of the actuator arm with respect to the actuator body when the first part and the second part are at the maximum distance; identify, with the sensor, an operating location of the actuator arm with respect to the actuator body when the actuator arm moves the first part to the maximum distance from the second part; identify a difference value by comparing the operating location to the starting location; and identify an amount of mechanical wear from the identified difference value.

In one example of this embodiment, the processor is further configured to execute the stored program instruction to: compare the identified amount of wear to a threshold value, and based on the comparison, identify excessive wear of one of the hydraulic actuator or one of the parts of the machine. In a second example of this embodiment, the processor is further configured to execute the stored program instructions to transmit a wear alert signal configured to identify the excessive wear, wherein the wear alert signal is transmitted to an alert device. In a third example of this embodiment, the first part is an implement and the second part is a fixed part of the vehicle. In a fourth example of this embodiment, the first part is an implement and the second part is a movable part of the vehicle, wherein the movable part is operatively connected to the user control device, wherein the user control device is configured to transmit a second command signal to move the second part with respect to a frame of the vehicle. In a fifth example of this embodiment, the processor is further configured to execute the stored program instructions to identify an amount of mechanical wear experienced by the actuator arm.

In a sixth example of this embodiment, the first part is an implement and the second part is one of a work vehicle frame or a work vehicle part. In a seventh example of this embodiment, the processor is further configured to execute the stored program instructions to identify, with the sensor, a second starting location of the actuator arm with respect to the actuator cylinder when the first part and the second part are at the minimum distance. In an eighth example of this embodiment, the processor is further configured to execute the stored program instructions to identify, with the sensor, a second operating location of the actuator arm with respect to the cylinder when the actuator arm moves the first part to the minimum distance from the second part. In a ninth example of this embodiment, the processor is further configured to execute the stored program instructions to identify a second difference value by comparing the second starting location to the second operating location to identify a second amount of mechanical wear.

In a further embodiment, there is provided a method for identifying wear in a work machine resulting from continual actuation of an implement of the work machine. The method includes identifying a maximum moving distance between the implement and a supporting part of the work machine; selecting a mechanical actuator including a sensor, an actuator body, and an arm having a fully retracted position and a fully extended position with respect to the actuator body, wherein an actuator distance between the fully retracted position and the fully extended position is greater than the maximum moving distance; operatively connecting the mechanical actuator to the implement and to the supporting part of the work machine; identifying, with the sensor, a starting position of the arm with respect to the actuator body at the maximum moving distance; identifying, with the sensor, an actuation position of the arm with respect to the actuator body when the arm moves the implement to the maximum moving distance from the supporting part; identifying a difference value by comparing the actuation position to the starting position; and identifying an amount of wear from the identified difference value.

In one example of this embodiment, the method further includes comparing the identified amount of wear to a threshold value, and based on the comparison, identifying excessive wear of one of the mechanical actuator or one of the supporting part of the work machine.

### BRIEF DESCRIPTION OF THE DRAWINGS

The above-mentioned aspects of the present invention and the manner of obtaining them will become more apparent and the invention itself will be better understood by reference to the following description of the embodiments of the invention, taken in conjunction with the accompanying drawings, wherein:

FIG. 1 is an elevational side view of a work vehicle, and more specifically, of a bulldozer such as a crawler dozer including a blade.

FIG. 2 is an elevational side view of another work vehicle, and more specifically, of a four wheel drive loader.

FIG. 3 is a schematic block diagram of a control system configured control the position of an implement and to determine mechanical wear resulting from repeated movement of an implement of a work vehicle.

FIG. 4 is a representational view of mechanical wear experienced by an actuator.

FIG. 5 is an elevational view of an arm completely extended from an actuator body.

FIG. 6 is an elevational view of an arm extended from an actuator body at a distance of less than a complete extension.

FIG. 7 is an elevational view of an arm retracted into an actuator body at a distance of less than a complete retraction.

FIG. 8 is a process diagram to determine the location of an actuator arm at initial startup.

FIG. 9 is a process diagram to determine values of mechanical wear resulting from continual use of an actuator.

FIG. 10 is a process diagram to provide an alert if mechanical wear resulting from continual use of an actuator exceeds a predetermined threshold.

### DETAILED DESCRIPTION

For the purposes of promoting an understanding of the principles of the novel invention, reference will now be made to the embodiments described herein and illustrated in the drawings and specific language will be used to describe the same. It will nevertheless be understood that no limitation of the scope of the novel invention is thereby intended, such alterations and further modifications in the illustrated devices and methods, and such further applications of the principles of the novel invention as illustrated therein being contemplated as would normally occur to one skilled in the art to which the novel invention relates.

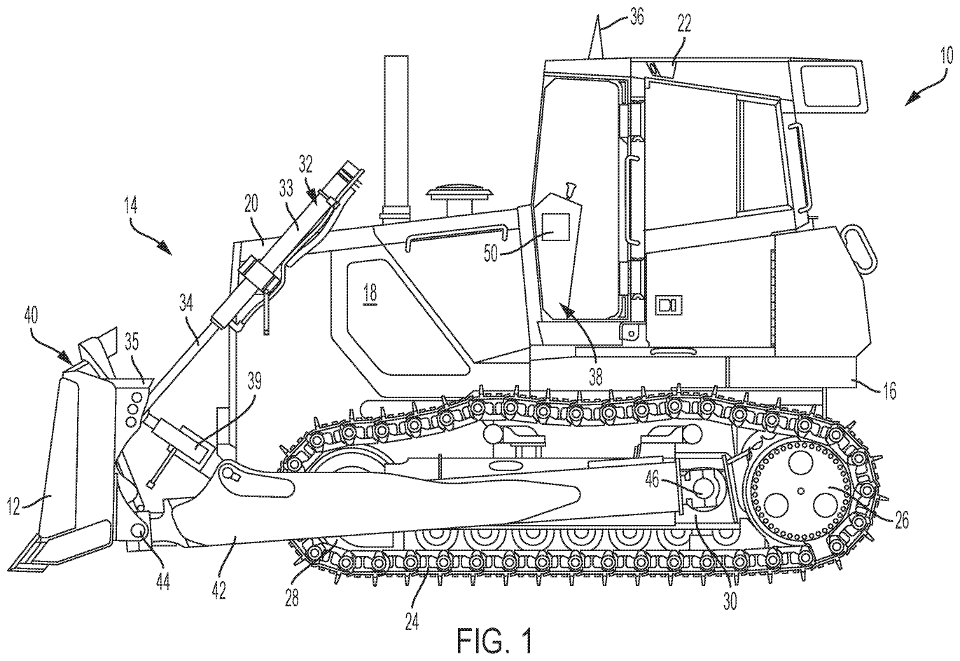

FIG. 1 is an elevational side view of a work vehicle 10, such as a crawler bulldozer, including an implement, such as a bulldozer blade 12, which is suitably coupled to the dozer by a linkage assembly 14. The vehicle includes a frame 16 which houses an internal combustion engine 18 located within a housing 20. The work vehicle 10 includes a cab 22 where an operator sits or stands to operate the vehicle. The vehicle is driven by a belted track 24 which operatively engages a rear main drive wheel 26 and a front auxiliary drive wheel 28. The belted track is tensioned by tension and recoil assembly 30. The belted track is provided with centering guide lugs for guiding the track across the drive wheels, and grousers for frictionally engaging the ground.

While the described embodiments are discussed with reference to a crawler bulldozer, other work vehicles are contemplated including other types of construction vehicles, forestry vehicles, lawn maintenance vehicles, as well as on-road vehicles such as those used to plow snow. Actuators used in one or more of these work vehicles includes tilt, angle, lift, arm, boom, bucket, blade side shift, blade tilt, and saddle side shift actuators or actuator cylinders.

The main drive wheels 26 are operatively coupled to a steering system which is in turn coupled to a transmission. The transmission is operatively coupled to the output of the internal combustion engine 18. The steering system may be of any conventional design and maybe a clutch/brake system, hydrostatic, or differential steer. The transmission may be a power shift transmission having various clutches and brakes that are actuated in response to the operator positioning a shift control lever (not shown) located in the cab 22.

The bulldozer blade 12 (the implement) is raised and lowered by actuators 32, such as hydraulic cylinders. While one actuator 32 is shown in FIG. 1, two actuators 32 are operatively connected to the blade 12 as is understood by one skilled in the art. Each of the actuators 32 includes a hydraulic actuator including a body 33, or cylinder, and an arm 34 that extends and retracts from the cylinder. The cylinder 33 is rotatably coupled to the frame 16 or housing 20 and the arm 34 is rotatably coupled to a plate 35 fixedly coupled to the blade 12. While a plate is described, other parts to connect the arm 34 to the blade 12 are contemplated including brackets, studs, pillars, lugs, rims, collars, and ribs.

One or more implement control devices 37, located at a user interface of a workstation 38, are accessible to the operator located in the cab 22. The blade 12 is tilted by actuators 39, such as hydraulic actuators or hydraulic cylinders, which adjust a tilt angle of the blade 12 moving an upper portion 40 of the blade 12 toward or away from the frame 16. Additional actuators, such as hydraulic cylinders, move the blade 12 left or right of a center longitudinal axis of the vehicle 10. The extension and retraction of the hydraulic cylinders is controlled by the operator through the control devices 37.

The implement control devices 37 are located at a user interface that includes a plurality of operator selectable buttons configured to enable the operator to control the operations and functions of the vehicle 10. The user interface, in one embodiment, includes a user interface device including a display screen having a plurality of user selectable buttons to select from a plurality of commands or menus, each of which are selectable through a touch screen having a display. In another embodiment, the user interface includes a plurality of mechanical push buttons as well as a touch screen. In still another embodiment, the user interface includes a display screen and only mechanical push buttons. In one or more embodiments, adjustment of blade with respect to the frame is made using one or more levers or joysticks.

Extension and retraction of the actuators 32 raises or lowers the blade 12 with respect to ground or another surface upon which the vehicle 10 is located. The blade 12 is rotatably coupled to a push arm 42 at a rotational axis 44 at one end of the push arm. The push arm 42 is rotatably coupled to the frame 16 at a rotational axis 46. Extension or retraction of the actuators 32 moves the blade 12 up or down as the push arm 42 rotates about the rotational axis 46.

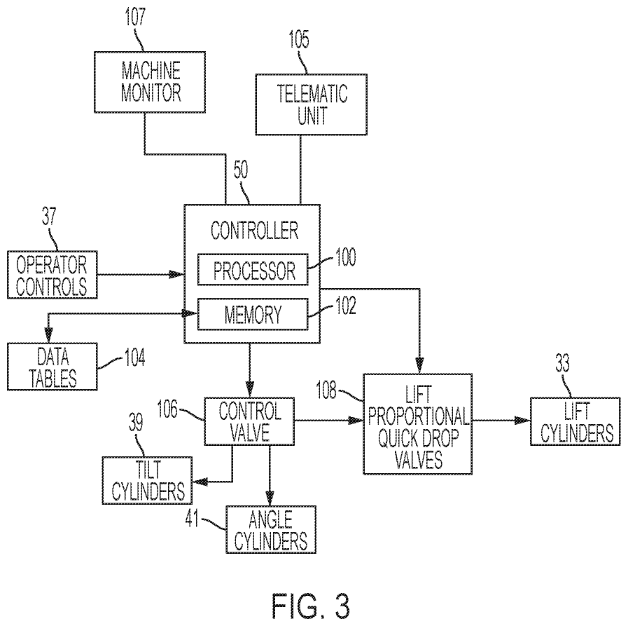

Adjustment of the actuators is made by the operator using the controls 37 which are operably coupled to a controller 50, as seen in FIG. 3, which in one embodiment, is located at the workstation 38. In other embodiments, the controller 50 is located at other locations of the work vehicle. As can be seen in FIG. 3, the operator control devices 37 are operatively connected to the controller 50 which is operatively to the tilt cylinders 39, angle cylinders 41, and to the lift cylinders 32.

In FIG. 1, an antenna 36 is located at a top portion of the cab 22 and is configured to receive and to transmit signals from different types of machine control systems and or machine information systems including a global positioning systems (GPS). While the antenna 36 is illustrated at a top portion of the cab 22, other locations of the antenna 36 are contemplated as is known by those skilled in the art.

Each of the actuators experiences continual use over extended periods of time and consequently, the actuator, and the parts of the work machine that the actuator is coupled to, experiences wear. If this wear is not identified sufficiently early, the wear if left unrecognized reduces the effectiveness of the movement of the implement. If use continues, the wear becomes excessive and results in damage to one or more of the actuator, the implement, or machine parts coupled to the actuator.

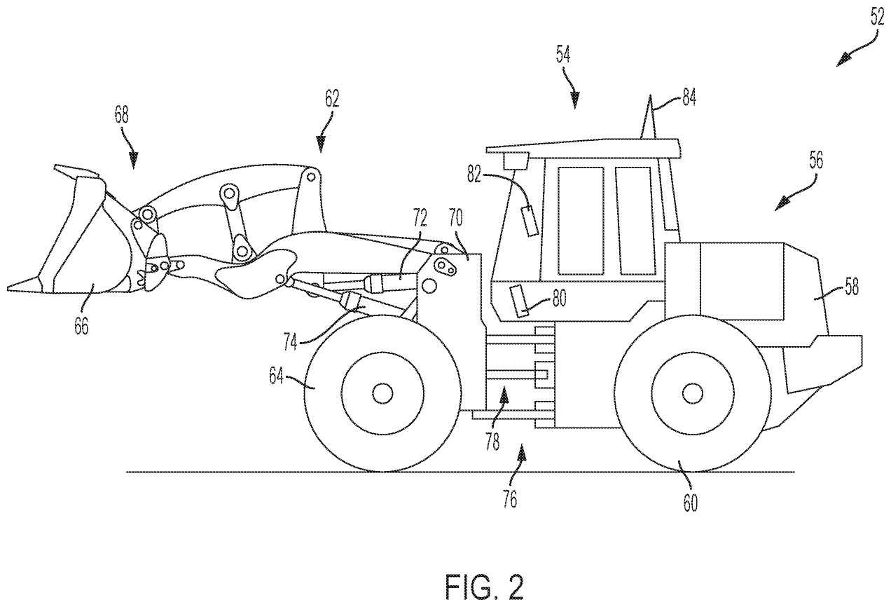

As described above, the mechanical actuator is used in a wide variety of work machines and consequently other types of work machines having mechanical actuators are contemplated. In one example as illustrated in FIG. 2., a four wheel drive (4WD) loader 52 includes a cab 54 and a rear body portion 56 having an engine enclosed by a housing 58. The rear body portion 56 includes rear wheels 60. A front body portion 62 includes front wheels 64, and supports a bucket 66. A linkage 68 is coupled to a frame 70 of the front body portion 62 to adjust a position of the bucket 66 with respect to the frame 70. Hydraulic cylinders 72 and 74 move the linkage 68 under control an operator located in the cab 54.

An articulation joint 76 enables an angular change between the front body portion 62 and the rear body portion 56. One or more hydraulic cylinders 78 adjust the angular position between the front and rear body portions 62 and 56 under hydraulic power provided by hydraulic pumps (not shown). The hydraulic pumps are part of a hydraulic system that provides the power to move the linkage 68 and which includes an oil cooler to reduce the temperature of the oil resulting from the work performed. In one or more embodiments, ground engaging traction devices, such as tracks, are used in place of the wheels 60 and/or 64. The present application is not limited to a 4WD loader and other types of vehicles are contemplated, including excavators, skid steers, and other loaders including two wheel drives and tracks.

An accelerator pedal 80 and a user interface 82 are located within the cab 54 for use by the operator of the vehicle 52. The accelerator pedal 80 enables the operator to adjust the speed of the vehicle. In other embodiments, a hand lever provides this function. An antenna 84 is located at a top portion of the cab 54 and is configured to receive and to transmit signals from different types of machine control systems and or machine information systems including a global positioning systems (GPS).

As illustrated by FIG. 2, hydraulic cylinders 78 are not configured to move an implement, but are instead configured to adjust the positon of the front body portion 62 with respect to the rear body portion 56. Consequently, the present disclosure is not limited to systems and methods including mechanical actuators that are configured to move implements, but other systems and methods including mechanical actuators configured to move one part of a work vehicle with respect to another part of a work vehicle are also contemplated. Other types of work vehicles having mechanical actuators are therefore contemplated including, but not limited to excavators and motor graders.

As seen in FIG. 3, the controller 50, in one or more embodiments, includes a processor 100 operatively connected to a memory 102. In still other embodiments, the controller 50 is a distributed controller having separate individual controllers distributed at different locations on the vehicles 10 or 52. In addition, while the controller is generally hardwired by electrical wiring or cabling to related components, in other embodiments the controller 50 includes a wireless transmitter and/or receiver to communicate with a controlled or sensing component or device which either provides information to the controller or transmits controller information to controlled devices.

The controller 50, in different embodiments, includes a computer, computer system, or other programmable devices. In other embodiments, the controller 50 includes one or more processors 100 (e.g. microprocessors), and the associated memory 102, which can be internal to the processor or external to the processor. The memory 102 includes, in one or more embodiments, random access memory (RAM) devices comprising the memory storage of the controller 50, as well as any other types of memory, e.g., cache memories, non-volatile or backup memories, programmable memories, or flash memories, and read-only memories. In addition, the memory can include a memory storage physically located elsewhere from the processing devices and can include any cache memory in a processing device, as well as any storage capacity used as a virtual memory, e.g., as stored on a mass storage device or another computer coupled to controller 50. The mass storage device can include a cache or other dataspace which can include databases. Memory storage, in other embodiments, is located in the “cloud”, where the memory is located at a distant location which provides the stored information wirelessly to the controller 50.

The controller 50 executes or otherwise relies upon computer software applications, components, programs, objects, modules, or data structures, etc. Software routines resident in the included memory of the controller 50 or other memory are executed in response to the signals received. The computer software applications, in other embodiments, are located in the cloud. The executed software includes one or more specific applications, components, programs, objects, modules or sequences of instructions typically referred to as “program code”. The program code includes one or more instructions located in memory and other storage devices that execute the instructions resident in memory, which are responsive to other instructions generated by the system, or which are provided at a user interface operated by the user. The processor 100 is configured to execute the stored program instructions as well as to access data stored in one or more data tables 104. A telematic unit 105, or a transmitter and/or receiver, is operatively connected to the antenna 36. The telematics unit 105 is configured to transmit and to receive wireless signals at the antenna 36. A machine monitor 107 is operatively connected to the controller 50 and is configured to monitor the positions of various movable part of the vehicle with respect to other parts, such as the blade 12 with respect to the frame 16.

The height of the blade 12 is adjusted by the extension and retraction of linear hydraulic actuators 33 which respond to movement of the operator control 37, such as a joystick. The joystick generates a command signal that is received by the controller 50, which determines the commanded position of the blade and generates a lift control command signal transmitted to an actuator lift control valve 106 and a proportional quick drop command signal transmitted to lift proportional quick drop valves 108. Each of the lift cylinders 33 is operatively connected to one of the actuator control valves 106 and to the lift proportional quick drop valve 108.

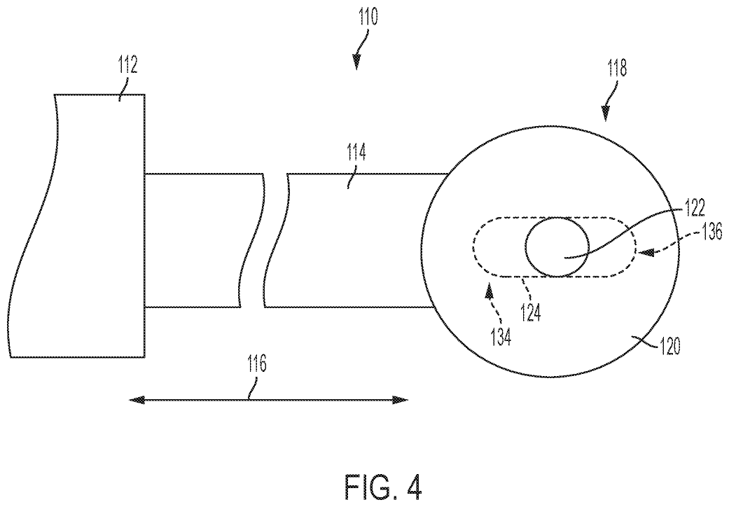

Over a period of time as the actuators continually adjust the location of one part with respect to another part, the actuator suffers wear. For instance as seen in FIG. 4, an actuator 110 includes an actuator body 112 and an actuator rod 114 that extends and retracts from the actuator body 112 along a line 116. The actuator rod 114 includes an end 118 having a coupler 120 having an aperture 122. The aperture 122 is generally circular and is configured to attached to a part to be moved, such as the blade 12, with a pin or other connecting device not shown. As the rod 114 continues to move along the line 116, either extending or retracting, the aperture 122 deforms along an expanded aperture 124 due to the forces applied as illustrated by the doted outline. Over a period of time consequently the aperture 122 becomes larger. As the aperture becomes larger, the location of the part being moved by the rod 114 becomes less precise. Over a period of time, the operator using the operator control 37 cannot manipulate the attached part, such as the blade 12, to a desired location and consequently, the operations being performed either take longer or do not achieve the desired outcome.

While the aperture 122 is shown as expanding to the dotted outline 124, the dotted outline is representational and the distortion of the aperture 122 takes many different forms. In addition, the part to which the coupler 122 is attached may also experience a distortion. Likewise, because the actuator body 112 is coupled to another location on the machine, the end of the actuator body 112 or the part to which the actuator body is coupled may experience distortion. In any event, the resulting distortion, no matter where located, is an undesirable result of the continual operation of the actuator requires either repair or replacement of the actuator, parts of the actuator, or parts of the machine to which the actuator is coupled.

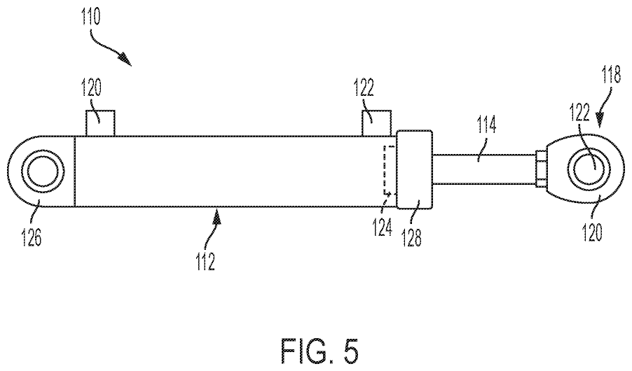

In different embodiments, one or more of the actuators is configured to include sensors to detect the location of the rod 114 with respect to the body 112. As seen in FIG. 5, the cylinder 110 includes a first sensor 120 and a second sensor 122 to sense a location of a sensed element 124 which is operatively connected to the rod 114. In the illustrated embodiment, the first sensor 120 determines the location of the sensed element 124 when the rod 114 is retracted into the actuator body 112 toward the end of a actuator body coupler 126. The second sensor 122 determines the location of the sensed element 124 when the arm is extended from the actuator body 112 toward and end 128. Each of the first and second sensors 120 and 122 are coupled to or are incorporated into the machine monitor 107 and are configured to determine the location of the sensed element with respect to the actuator body 112.

In one or more embodiments, the actuators include but are not limited to sensors located on, near, or within the actuator body 112. In different embodiments, a sensor system including both the sensor and the sensed element 124 include: a rod that trips a micro-switch or a pneumatic valve; pressure threshold sensors that responds to a drop in exhaust pressure once the rod stops moving; magnetic sensor mounted directly to the actuator body to sense a magnetic field of a magnet acting as the sensed element that is coupled to the rod; one or more reed switches triggered by the rod; Hall effect sensor triggered by a magnetic sensed element; pneumatic reed valve triggered by a magnetic sensed element; photoelectric elements; inductive elements; or capacitive elements. Other types of sensor systems are contemplated.

In known actuators, the maximum extension of the rod from the cylinder body determines the maximum position of the part being moved by the rod with respect to the other part of the machine to which the cylinder is attached. The minimum extension of the rod from the cylinder body determines the minimum position of the part being moved. Consequently, if two machine parts are to be separated by a maximum distance of 10 inches for instance, the distance traveled by the rod from its retracted position to its extended position is 10 inches. The actuator determines the a maximum distance of extension to identify an extend reference location and a minimum distance of extension to identify an retracted reference location.

In one or more embodiments of the present invention, however, an actuator is selected having a distance between a minimum extension and a maximum extension of greater that a minimum distance and maxim distance of the part being moved. For instance using the above example of 10 inches of movement, a cylinder having 12 inches of movement between the minimum distance and the maximum distance is employed and the part or parts being moved include mechanical stops incorporated into the parts themselves. Consequently, the maximum distance and the minimum distance of parts of a new work machine are fixed by the machine parts and not the actuator.

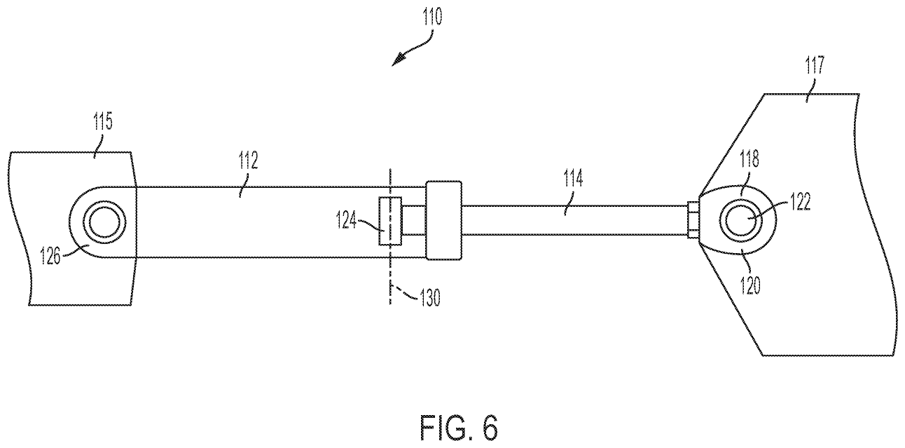

For a new build, the maximum extension of the rod 114 is fixed by parts 115 and 117 of the machine and consequently the machine limits the maximum extension of the rod 114. At the maximum extension is a maximum location of the rod before wear has occurred. As illustrated in FIG. 6, for example, the arm 114 is extended to a percentage of full extension, which in this case is 95% at line 130. While the arm is extended to a percentage of full extension, the distance between machine parts is 100% as determined by the machine and/or its parts.

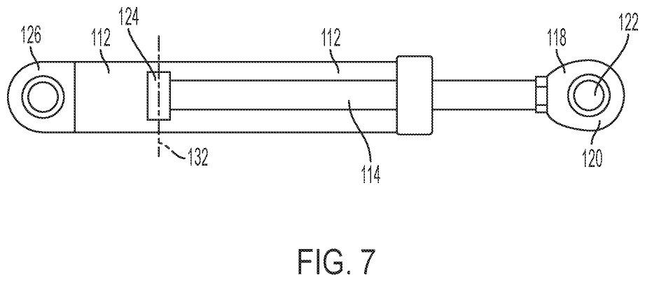

When the machine parts are moved to their closest position for a new machine, the rod 114 is not fully retracted as illustrated in FIG. 7. In this position, the end 124 is located at a percentage of full extension, which in this example is 5% at line 132.

As the aperture 122 deforms along the outline of expanded aperture 124, as illustrated in FIG. 4, the expanded aperture 124 permits the rod 114 to move further in either direction along the line 116. When the rod 114 moves to full extension, for instance, the rod 114 has more room to move toward an end 134 of the aperture 124 that permits a greater extension of the rod 114 from the body 112. With this movement, the sensed element 124 is located at a position between 95% and 100% of rod extension. Because the location of the sensed element 124 has changed, wear at the aperture 122 is identified. Likewise, when the rod 114 moves to full retraction, the aperture 124 permits a greater retraction of the rod toward an end 136. With this movement, the sensed element 124 is located at a position of between 0% and 5% in this example. The sensors 120 and 122 therefore identify wear due to the changing location of the sensed element over a period of use.

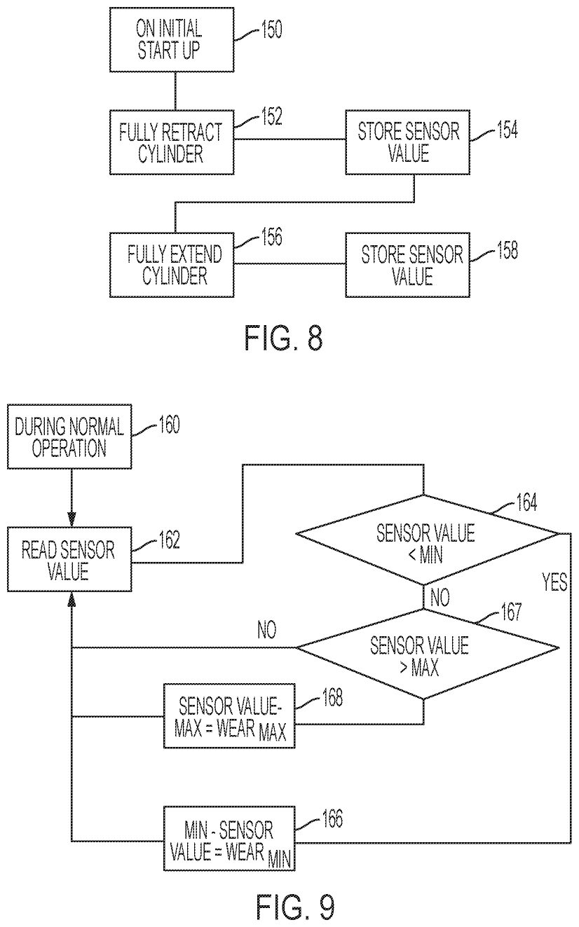

As described above, each of the first and second sensors 120 and 122 is coupled to, or are incorporated into, the machine monitor 107 and are configured to determine the location of the sensed element 124 with respect to the actuator body 112. The location information provided by each of the sensors 120 and 122 is used in a process diagram of FIG. 8.

When a new vehicle is put into operation or a used vehicle has been repaired or modified to correct an issue of wear, the process begins at block 150, i.e. on initial startup. When the vehicle has been started, the arm 114 of the cylinder is fully retracted at block 152. The location of the sensed element 124 is identified by the sensor 120 and stored at block 154 in the data table 104 of FIG. 3. This stored value is identified as a minimum initial value. The arm 114 of the cylinder 110 is also fully extended at block 156 and the location of the sensed element 124 is identified by the sensor 122 and stored at block 158 in the data table 104. This stored value is identified as a maximum initial startup value. The order of the identification of the minimum value and the maximum value of the location of the sensed element 124 at full extension and full retraction is not determinative.

Once the minimum and maximum initial values are stored, a process is performed during normal operation beginning at block 160 of FIG. 9. As the work machine operates, and in particular as the actuator rods are extending and retracting, the location of the sensed element 124 is identified by the sensor 120 and the sensor 122 at block 162. Each of the sensors 120 and 122 identify the location of the sensed element at block 162. The sensor value identified by the sensor 120, i.e. a retracted operation value, is compared to the minimum initial value at block 164 to determine whether the retracted operation value is less than the minimum initial value. If the result of this comparison is yes, the identified retraction operation value is subtracted from the minimum initial value and set to a minimum wear value at block 166. The sensor value identified by the sensor 122, i.e. an extended operation value, is compared to the maximum initial value at block 167 to determine whether the extended operation value is greater than the maximum initial value. If the result of this comparison is yes, the extended operation value is subtracted from the maximum initial value and set to a maximum wear value at block 168.

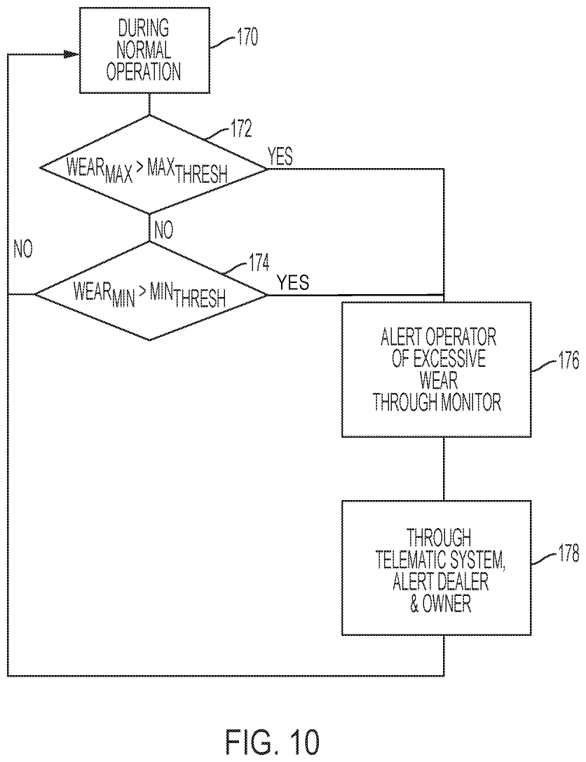

Once the maximum wear value and the minimum wear values are determined, an alert process as described in FIG. 10 takes place. During normal operation beginning at block 170, the processor 50 compares the maximum wear value to a maximum threshold value at block 172. The processor 50 also compares the minimum wear value to a minimum wear threshold value at block 174. If the outcome of either the comparisons at blocks 172 and 174 are yes, then a wear alert signal is generated by the processor 50 and is transmitted to an alert device located at the machine monitor 107, a user interface, or at another alert device located at the workstation 38, such as illumination device or an sound generation device. Upon receipt of the transmitted alert signal, the operator is notified of excessive wear at block 176. In this embodiment, the alert signal is also transmitted to the telematic unit 105, which in turn transmits the alert signal wirelessly to a work machine dealer, owner, manufacturer, or lessor at block 178.

While exemplary embodiments incorporating the principles of the present disclosure have been described hereinabove, the present disclosure is not limited to the described embodiments. Instead, this application is intended to cover any variations, uses, or adaptations of the disclosure using its general principles. For instance, other types of machines including stationary machines using mechanical actuators, such as assembly machines used in a manufacturing facility, are contemplated. In addition, while the terms greater than and less than have been used in making comparison, it is understood that either of the less than or greater than determines can include the determination of being equal to a value. Further, this application is intended to cover such departures from the present disclosure as come within known or customary practice in the art to which this disclosure pertains and which fall within the limits of the appended claims.

1. A method for identifying wear of a mechanical actuator having a sensor, a cylinder, and a piston rod configured to extend and retract from the cylinder, wherein the mechanical actuator is operatively connected to a first part of a machine and to a second part of the machine to move the first part with respect to the second part in response to a machine command transmitted by an electronic control module, the method comprising:
identifying, with the sensor, a retracted reference location of the piston rod based on a minimum distance between the first part and the second part;
identifying, with the sensor, an extended reference location of the piston rod based on a maximum distance between the first part and the second part;
comparing one of the retracted reference location and extended reference location to one or more threshold values to generate a comparison value; and
identifying an amount of mechanical wear experienced by one of the mechanical actuator or the machine based on the comparison value.

2. The method of claim 1 wherein the identified amount of mechanical wear is wear experienced by the piston rod or the mechanical actuator.

3. The method of claim 1 wherein the identified amount of mechanical wear is wear experienced by one of the first part of the second part.

4. The method of claim 2 wherein the one or more threshold values of the comparing step includes a first threshold value and a second threshold value, wherein the first threshold value is compared to the retracted reference value and the second threshold value is compared to the extended threshold value to identify an amount of mechanical wear of the mechanical actuator.

5. The method of claim 4 wherein the identifying step further comprises identifying an amount of mechanical wear experienced by the piston rod.

6. The method of claim 5 wherein the first part of the machine is an implement, the second part of the machine is one of a frame or a moving part operatively connect to the frame, and the piston rod includes an aperture, wherein the aperture of the piston rod is coupled the implement and the mechanical wear occurs at the piston rod.

7. The method of claim 1 wherein the piston rod includes a fully extended position and a position of the piston rod at the extended reference location does not extend to the fully extended position.

8. The method of claim 7 wherein the piston rod includes a fully retracted position and a position of the piston rod at the retracted reference location does not extend to the fully retracted position.

9. A work vehicle comprising:
a first part and a second part, the first part configured to move with respect to the second part, wherein the first part is displaced from the second part at a minimum distance, at a maximum distance, and at locations therebetween;
a hydraulic actuator including a sensor, an actuator body, and an actuator arm, wherein the actuator arm is operatively connected to the first part and the actuator body is operatively connected to the second part;
a user control device operatively connected to the hydraulic actuator and configured to transmit a first command signal to move the actuator arm of the hydraulic actuator with respect to the actuator body;
an electronic user interface configured to provide status information of the work vehicle; and
an electronic control unit operatively connected to the sensor, to the user control device, and to the electronic user interface, the electronic control unit including a processor and a memory, wherein the memory is configured to store program instructions and the processor is configured to execute the stored program instructions to:
identify, with the sensor, a starting location of the actuator arm with respect to the actuator body when the first part and the second part are at the maximum distance;
identify, with the sensor, an operating location of the actuator arm with respect to the actuator body when the actuator arm moves the first part to the maximum distance from the second part;
identify a difference value by comparing the operating location to the starting location; and
identify an amount of mechanical wear from the identified difference value.

10. The work vehicle of claim 9 wherein the processor is further configured to execute the stored program instruction to:
compare the identified amount of wear to a threshold value; and
based on the comparison, identify excessive wear of one of the hydraulic actuator or one of the parts of the machine.

11. The work vehicle of claim 10 wherein the processor is further configured to execute the stored program instructions to transmit a wear alert signal configured to identify the excessive wear, wherein the wear alert signal is transmitted to an alert device.

12. The work vehicle of claim 11 wherein the first part is an implement and the second part is a fixed part of the vehicle.

13. The work vehicle of claim 11 wherein the first part is an implement and the second part is a movable part of the vehicle, wherein the movable part is operatively connected to the user control device, wherein the user control device is configured to transmit a second command signal to move the second part with respect to a frame of the vehicle.

14. The work vehicle of claim 9 wherein the processor is further configured to execute the stored program instructions to identify an amount of mechanical wear experienced by the actuator arm.

15. The work vehicle of claim 14 wherein the first part is an implement and the second part is one of a work vehicle frame or a work vehicle part.

16. The work vehicle of claim 14 wherein the processor is further configured to execute the stored program instructions to identify, with the sensor, a second starting location of the actuator arm with respect to the actuator cylinder when the first part and the second part are at the minimum distance.

17. The work vehicle of claim 10 wherein the processor is further configured to execute the stored program instructions to identify, with the sensor, a second operating location of the actuator arm with respect to the cylinder when the actuator arm moves the first part to the minimum distance from the second part.

18. The work vehicle of claim 17 wherein the processor is further configured to execute the stored program instructions to identify a second difference value by comparing the second starting location to the second operating location to identify a second amount of mechanical wear.

19. A method for identifying wear in a work machine resulting from continual actuation of an implement of the work machine, the method comprising:
identifying a maximum moving distance between the implement and a supporting part of the work machine;
selecting a mechanical actuator including a sensor, an actuator body, and an arm having a fully retracted position and a fully extended position with respect to the actuator body, wherein an actuator distance between the fully retracted position and the fully extended position is greater than the maximum moving distance;
operatively connecting the mechanical actuator to the implement and to the supporting part of the work machine;
identifying, with the sensor, a starting position of the arm with respect to the actuator body at the maximum moving distance;
identifying, with the sensor, an actuation position of the arm with respect to the actuator body when the arm moves the implement to the maximum moving distance from the supporting part;
identifying a difference value by comparing the actuation position to the starting position; and
identifying an amount of wear from the identified difference value.

20. The method of claim 19 further comprising comparing the identified amount of wear to a threshold value; and
based on the comparison, identifying excessive wear of one of the mechanical actuator or one of the supporting part of the work machine.
